(19) United States
(12) Patent Application Publication
(10) Pub. No.: US 2021/0378434 A1
(43) Pub. Date: Dec. 9, 2021

(54) METHOD FOR PRODUCING GROMMETED DRAPERY TO ORDER

(71) Applicant: Kyle T. Turner, Inc., Lake Worth, FL (US)

(72) Inventor: Kyle Thomas Turner, Lake Worth, FL (US)

(21) Appl. No.: 16/897,124

(22) Filed: Jun. 9, 2020

(51) Int. Cl. A47H 13/02; B41J 3/407; B41M 5/035; A47H 23/00

(52) U.S. Cl. CPC A47H 13/02; A47H 23/00; B41M 5/035; B41J 3/4078

(57) ABSTRACT

A method of producing custom grommeted drapery that minimizes the need for inventorying of materials includes printing selected patterns or designs on assembled blank drapery. The blank drapery includes all of the layers of textile joined together as a unit, include a printing side or layer and a blackout side or layer. The blank drapery also have grommet holes punched in them, before or after printing the drapery. Once a selection is made, a blank drapery is then printed using the selected design, and then grommets can be assembled into grommet holes punched through the drapery along a top edge of the drapery. The inventive process obviates the need to inventory multiple different materials that are conventionally assembled together after printing a layer of textile for finishing.

### FIELD OF THE INVENTION

The present invention relates generally to draperies, and, more particularly, relates to methods of producing grommeted drapes in a way that minimizes inventorying of materials.

### BACKGROUND OF THE INVENTION

Drapery is a common window dressing that people use to not just for obstructing windows and doorways, but also as a decorative element. As such, it is common that the inside-facing side of a drapery is colored and/or patterned, and a person selects the design they want for their particular taste. Conventionally, draperies are made joining several layers of textile together into a sheet-like article that is hung. The several layers of textiles include, on one side of the drapery, a sheet or layer of textile that has a design on it. Accordingly, to provide people with an assortment of drapery designs from which to choose, numerous different draperies with different designs, and in various different sizes, must be made and offered for sale.

In order to provide a wide variety of drapery designs, then, drapery manufacturers must purchase various different textile materials that have different designs. These must all be stored and inventoried. Then a run of draperies using one of the design textiles is made where the design textile is cut to a selected size, and joined to other textile layers to form the drapery. The joining can be accomplished by sewing the layers together, by gluing the layers together, or any other textile layer joining technique. The manufacture must then package and ship the draperies to various distributors are retailers. Thus, a very large number of different drapery designs must be sourced, manufactured, shipped, inventoried, and so on. As a result, the industry must estimate how much of a given design will ultimately sell in order to optimize productivity. The effort in creating draperies can be reduced for the manufacturer by using an order model, where distributors and retailers select the designs they want to buy, and the manufactures fulfil the order by sourcing the corresponding design textiles and making the draperies.

An alternative to making a variety of draperies with various designs, and inventorying, distributing, and marketing them, is to create custom or “build to order” draperies. In this approach the end buyer selects or provides a pattern or graphic that they want on their draperies, and the manufactures makes the draperies using, for example, printing techniques. However, this approach still requires the manufacturer to print the design on one textile, and then join it to backing texting and often a liner.

Therefore, a need exists to overcome the problems with the prior art as discussed above.

### SUMMARY OF THE INVENTION

In accordance with some embodiments the inventive disclosure provides a method for making grommeted draperies. The method includes receiving, at a server from a client device, a selection of a selected drapery design, and configuring a drapery printer with the selected drapery design by transmitting a digital representation of the selected drapery design to a printer controller of the drapery printer. The method can further include printing the selected drapery design onto a blank drapery to produce a printed drapery. The blank drapery is a fully assembled blackout drapery having holes punched therethrough along a top edge, the holes being sized to receive a grommet. The method can further include installing a plurality of grommets into the holes along the top edge of the printed drapery to produce a finished drapery.

In accordance with another feature, printing the selected drapery design comprises printing the selected drapery design using sublimation printing.

In accordance with another feature, printing the selected drapery design includes printing the selected drapery design in a mirror image of the selected drapery design onto a transfer sheet using sublimation inks to produce a printed transfer sheet, and aligning the printed transfer sheet onto a printing side of the blank drapery with an ink side of the transfer sheet against the printing side of the blank drapery. The printing side of the blank drapery is made of a polyester material. The method can then further include passing the blank drapery with the transfer sheet together through a transfer device that sublimates the sublimation ink into the printing side of the blank drapery to produce the printed drapery.

In accordance with another feature, printing the selected drapery design onto the blank drapery to produce the printed drapery is performed by printing ink directly onto a printing side of the blank drapery.

In accordance with another feature, installing the plurality of grommets comprises installing the plurality of grommets by snapping together opposing grommet halves in each one of the holes.

In accordance with another feature, the method can further include, prior to installing the plurality of grommets, printing another design on an opposing side of the blank drapery.

In accordance with another feature, printing the selected drapery design includes printing a background color.

In accordance with another feature, receiving the selection of the selected drapery design comprises receiving an uploaded design image from the client device.

In accordance with some embodiments, the inventive disclosure provides a grommeted drapery that includes a blackout side and a printed side coupled to the blackout side. The printed side having been printed with a selected drapery design. The grommeted drapery further including a plurality of grommets along a top edge of the grommeted drapery, where each one of the plurality of grommets passes through both the blackout side and the printed side. The printed side is printed while attached to the blackout side as a blank drapery, and the blank drapery includes a plurality of grommet holes, and the printed side is printed before the plurality of grommets are installed in the plurality of grommet holes.

In accordance with a further feature, the printed side is printed by printing a mirror image of the selected drapery design onto a transfer sheet using sublimation ink, aligning the transfer sheet onto a printing side of the blank drapery, and passing the blank drapery and transfer sheet through a transfer device that applies heat and pressure to the transfer sheet and the blank drapery thereby cause the sublimation ink to sublimate into the printing side of the blank drapery to create the printed side.

In accordance with another feature, the printed side of the printed drapery is printed by printing ink directly onto a printing side of the blank drapery.

In accordance with some embodiments, the inventive disclosure provides a method for producing grommeted draperies while minimizing inventorying of materials. The method can include providing, by a server, a web page including client-side code that allows a user at a client device to browse a plurality of drapery designs and indicate a selection of one of the plurality of drapery designs. The method can further include receiving, at the server, an indication of a selection of a drapery design, and creating an order for fulfilment including the indication of the selection of the drapery design as a selected drapery design and an identification of the user. The method can further include configuring a drapery printer with the selected drapery design by transmitting a digital representation of the selected drapery design to a printer controller of the drapery printer. The method can further include printing the selected drapery design onto a blank drapery to produce a printed drapery, wherein the blank drapery is a fully assembled blackout drapery having holes punched therethrough along a top edge, wherein the holes are sized to receive a grommet. The method can further include, after printing the selected drapery design onto the blank drapery to produce the printed drapery, installing a plurality of grommets into the holes along the top edge of the printed drapery to produce a finished drapery.

In accordance with another feature, printing the selected drapery design comprises printing the selected drapery design using sublimation printing.

In accordance with another feature, printing the selected drapery design includes printing the selected drapery design in a mirror image of the selected drapery design onto a transfer sheet using sublimation inks to produce a printed transfer sheet, and aligning the printed transfer sheet onto a printing side of the blank drapery with an ink side of the transfer sheet against the printing side of the blank drapery. The printing side of the blank drapery is made of a polyester material. The method can then further include passing the blank drapery with the transfer sheet together through a transfer device that sublimates the sublimation ink into the printing side of the blank drapery to produce the printed drapery.

In accordance with another feature, printing the selected drapery design onto the blank drapery to produce the printed drapery is performed by printing ink directly onto a printing side of the blank drapery.

In accordance with another feature, installing the plurality of grommets comprises installing the plurality of grommets by, for each hole, snapping together opposing grommet halves.

In accordance with another feature, the method can further include, prior to installing the plurality of grommets, printing another design on an opposing side of the blank drapery.

In accordance with another feature, printing the selected drapery design includes printing a background color.

In accordance with another feature, receiving the selection of the selected drapery design comprises receiving an uploaded design image from the client device.

Although the invention is illustrated and described herein as embodied in a method for creating printed drapery, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a system diagram of a system for selecting, ordering, and manufacturing a drapery, in accordance with some embodiments;

FIG. 2 shows a process for printing a finished blank blackout drapery, in accordance with some embodiments;

FIG. 3 shows a printed drapery having grommets added to it after a printing process, in accordance with some embodiments;

FIG. 4 shows a printed drapery with grommets attached, in accordance with some embodiments; and

FIG. 5 shows a flow chart diagram of a method for selecting, ordering, and manufacturing a drapery, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The inventive method minimizes inventorying of materials in the production and manufacture of draperies by allowing a user to select a pattern, including colors, scaling, and other aspects of the pattern, and order drapes with the selected pattern. The selected pattern can be a pattern provided by the manufacturer, or uploaded by the purchaser to the manufacturer's system. The conventional approach to custom drapery uses a similar method, allowing a purchaser to select a pattern, and the pattern is then printed onto a layer of textile. The printed layer is then joined to other layers, depending on the type of drapery being ordered, and the drapery is finished by adding hardware or other features that facilitate mounting of the drapery. This prior art method, however, still requires inventorying of various backings and finishing materials, and requires the joining of the printed layer of textile to a selected type of backing or lining. The inventive method avoids these problems by using semi-finished blank draperys, which are sewn or joined layers of textile that have holes punched along the top edge for grommets. Once a blank is printed, the grommets are added and the drapery is complete and ready to be shipped to the purchaser.

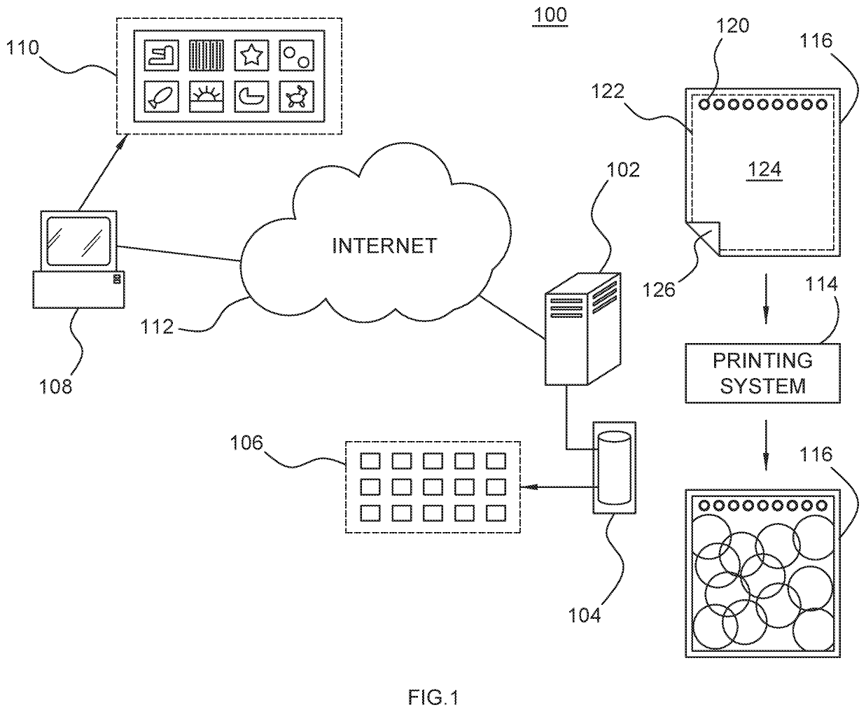

FIG. 1 is a system diagram of a system 100 for selecting, ordering, and manufacturing a drapery, in accordance with some embodiments. The manufacturer can provide a computing resource such as a server 102 that is operably coupled to a database 104. Although shown here as discrete elements, the server and database functions can be provided by a data center that includes multiple server elements for parallel processing. In some embodiments, such as an in-store embodiment, the server 102 can be a general purpose computer, and the database 104 can be implemented in a bulk storage device such as a hard drive. The client device 108 can be a general purpose computer, a mobile device, or other computing device capable of communicating with the server 102.

The database 104 contains a plurality of pattern files 106 that each include a graphical depiction of the pattern that is displayed on a client device 108 which is in communication with the server 102 over a network such as the internet 112. The server 102 can provide client-side code that is rendered by a browser at the client device 108 to allow a user to browse various drapery designs 106 and other options, as well as to allow a user to select or upload a design and order a drapery with the selected design. Additional elements can be included such as, for example, color selections, sizes, indication of similar patterns, and so on. In some embodiments the patterns can be displayed on the client device 108 along with a color wheel or similar interface that allows the purchaser to select a color scheme or specific colors. The patterns can be browsed on a browser window 110 on the computer where the server 102 can provide code for an interface that allows the purchaser to browse patterns, select patterns, view various colors applied to a selected pattern, and ordering interface elements to allow the purchaser to order a selected pattern and drape size.

Once the purchaser decides on pattern and drape size, an order is created at the server 102. The order can be queued at the server 102 for processing by a printing system 114. When the order is ready to be processed for fulfillment, the server 102 can transmit a digital representation of the selected design to the printing system 114. The printing system 114 includes a drapery printer having a printer controller and computing equipment necessary to operate the printer. Printing, in some embodiments, can be done by transfer, where the selected pattern (including colors) for a given order is printed onto transfer paper using sublimation ink, and the transfer paper and blank drapery 116 are passed through a transfer roller device that applies heat and pressure to transfer ink from the transfer paper into the fibers of the printing side 124 that is a polyester material. The printed paper is then paced onto a blank drapery 116. In some embodiments the printing can be done by printing ink directly onto the drapery using textile inks and a X-Y axis controlled printing head. Typically in an X-Y axis printer, the blank drapery is moved under a print head in one direction (the “Y” axis) and the print head is controlled to move in a direction perpendicular to the movement of the blank drapery (the “X” axis).

The blank drapery 116 is a blank blackout drapery unit that includes all of the layers of textile assembled together such as by, for example, a hem 122 around the edges of the drape. One side 124 of the blank drapery unit 116 is a textile material suitable for printing. In some embodiments the blank drapery 116 can be a foam-backed opaque fabric, as is commonly used in blackout drapery. The blank drapery 116 includes a plurality of holes 120 along the top edge of the blank drapery 116. The holes 120 are grommet holes and are sized to receive a grommet after being printed. The blank drapery 116 is processed by the printing system 114 to produce a printed drapery 118 in which the blank or printing side 124 becomes a printed side. Grommets can then be joined in the holes 120 to produce a fully assembled blackout drapery that can then be packaged and shipped to the purchaser as a finished grommeted drapery.

The blank drapery 116 can have a printing side 124 and an opposing side 126. These can be separate layers of textile that are joined together to create the blank drapery 116. The opposing side 126 can be a blackout side or layer that comprises well known blackout material commonly used in drapes. The two sides 124, 126 can be joined by any known textile joining technique or method, including sewing or gluing the sides together to create the blank drapery 116. In some embodiments both sides 124, 126 can be blank sides that are printed on to create a double printed drapery. A person can chose an interior-facing pattern and an exterior-facing pattern. In a double sided blank drapery, the blank drapery can include a third interior layer, between the two sides 124, 126, that is made of blackout material. Furthermore, it is contemplated that the printing side 124 (as well as 126 if a double sided blank drapery) can have color that is other than white. Various shades of white, or pale colors can be used. That is, the textile layer used for the printing side 124 can be made of a colored fabric as a background color for the selected pattern. Background colors can be selected when selecting the pattern to be printed on the blank drapery. Alternatively, the pattern can include a background color that is printed onto an initially white blank drapery 116.

Although shown here as an internet-based embodiment, as mentioned, an equivalent arrangement can be used for a local system. In a local system embodiment, the computer 108 can be co-located with the server 102, and connected over a local network. Alternatively, the server 102 can be a general purpose computer that provides the capability of the client device 108 as well. The server 102 and client device 108 functionality can be located together in an establishment to allow people to come to the establishment, browse patterns both on the computer and actual printed patterns, and decide which pattern they would like. In some embodiments a test blank can be printed using the selected pattern, using a scaled down version of the process for creating a full sized printed drapery.

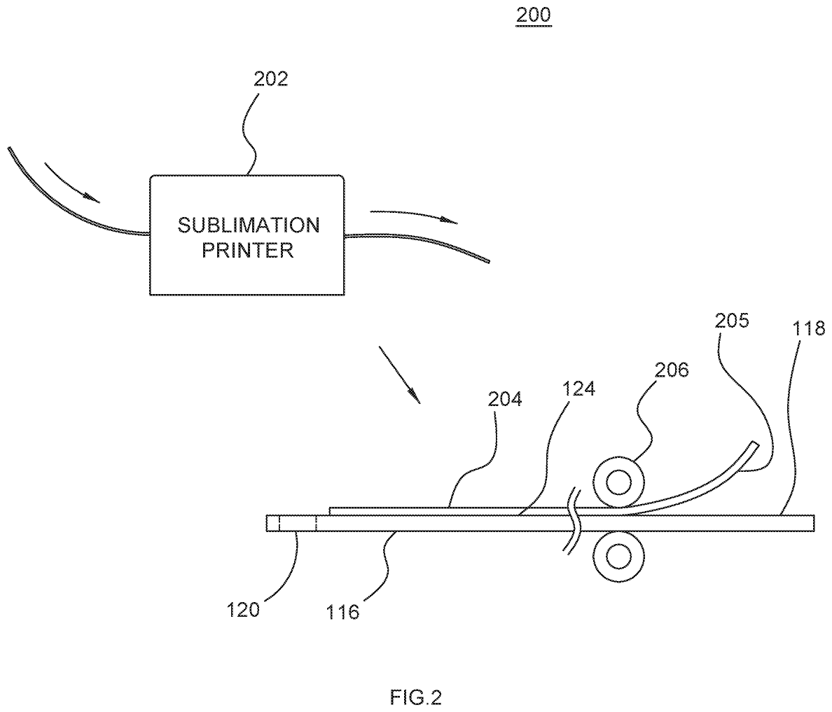

FIG. 2 shows a process diagram 200 for printing a finished blank blackout drapery, in accordance with some embodiments. A sublimation printer 202 prints a selected pattern onto a transfer sheet 204 as a mirror image of the selected design to be printed to produce a printed transfer sheet. The printed transfer sheet 204 is sized to correspond with the side 124 of the blank drapery 116, and is placed on and aligned with the side 124. The blank drapery 116 and the printed transfer sheet 204 are then passed through a transfer device 206 with the ink side 205 of the printed transfer sheet 204 facing the printing side of the drapery. The transfer device can include a calender that applies heat and pressure to cause ink from the transfer sheet 204 to transfer to the side 124 of the blank drapery to produce a printed drapery 118. In the sublimation process, while passing through the transfer device 206 the ink on the transfer sheet 204 turns into a gas and is infused into the polyester material of the fabric of the side 124. As a result, the ink transfer is permanent.

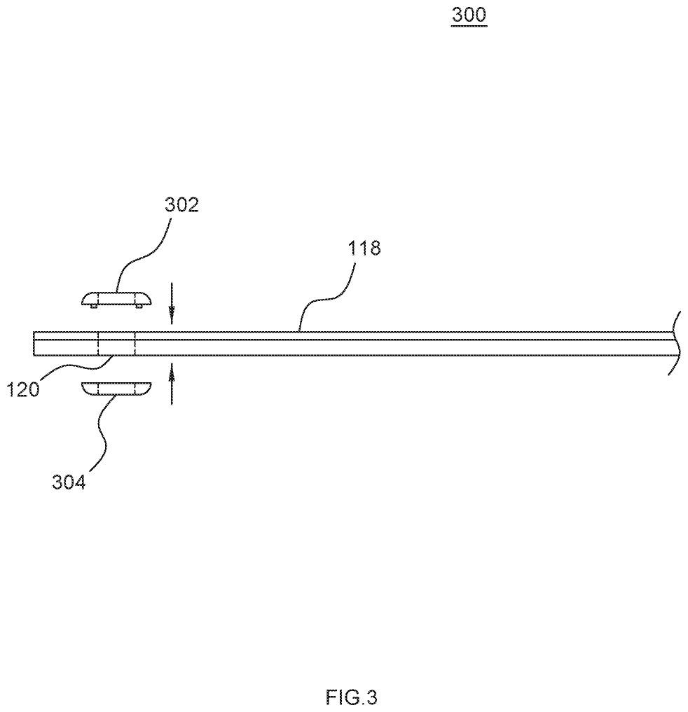

FIG. 3 shows a printed drapery having grommets added to it after a printing process, in accordance with some embodiments. Grommets are added after the printing process because the grommets would not pass through the transfer device 206. The holes 120 are cut for a given size grommet, which can be formed by a first half 302 and a second half 304, which can snap together. The grommet halves 302, 304 can have features that press into the sides of the drapery to prevent them from moving or turning once assembled together, as is known. Each of the holes 120 receive a respective grommet until all of the holes have grommets. Once the grommets are all in place, the printed drapery is finished and ready to be packaged. Each grommet comprises an annular member having an outside diameter that is greater than the diameter of the holes 120, and an opening that is smaller in diameter than the diameter of the holes 120. Accordingly, the curtilage of drapery fabric around each hole is covered and engaged by the grommet halves 302, 304, and the grommet provides an opening therethrough that is surrounded by the rigid material of the grommet, which supports the drape and facilitates movement over the drapery pole or rod to allow users to open and close the drapery repeatedly without producing wear on the drapery fabric around the holes.

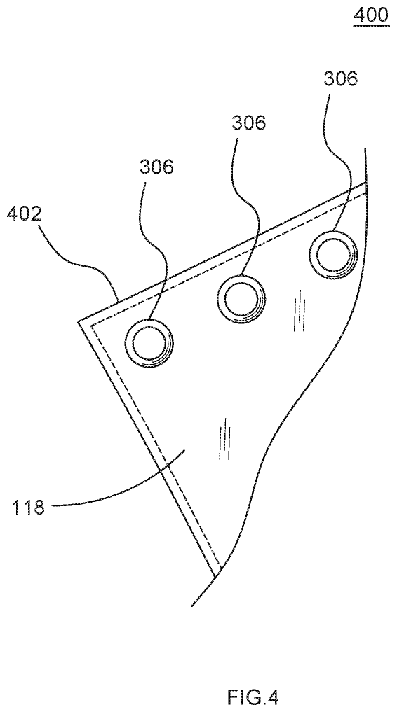

FIG. 4 shows a printed drapery 118 with grommets attached, in accordance with some embodiments. The printed drapery 118 is shown assembled with grommets 306 arranged along the top edge 402 of the drapery. Each grommet 306 includes an opening to allow the drapery to be supported on a rod that passes through the openings by folding the drapery between the grommets, which turns them substantially perpendicular to the place of the major portion of the drapery.

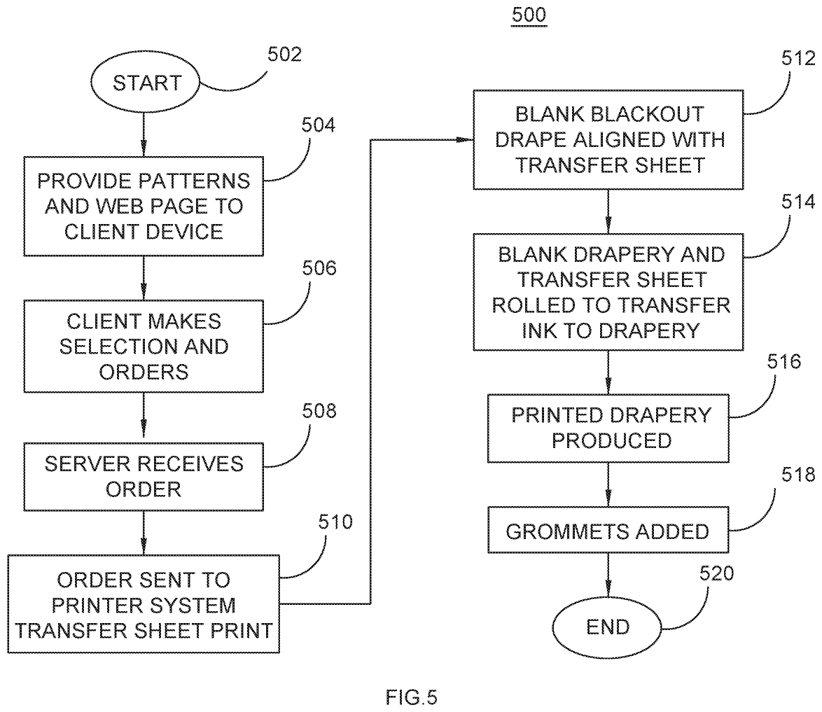

FIG. 5 shows a flow chart diagram of a method 500 for selecting, ordering, and manufacturing a drapery, in accordance with some embodiments. At the start 502 a manufacturer can have a networked, publicly accessible computing resource set up that allows users to browse available patterns, select colors, or upload graphics from a remote client computer over a network. In step 504, upon a user using a computer to connect to the manufacturer's computing resource, the user's computer can receive data and code for rending a web page to allow the user to browse information, including graphics, and navigate through various pages using hyperlinks associated with rendered text or objects. In particular the user can be presented with selection of patterns to choose from, and blank drapery can be graphically rendered on which a selected pattern can further be rendered to give the user an idea as to what a drapery made using that pattern would look like. That can include patterns uploaded by the user.

In step 506 the user can make a final selection of a pattern (a selected drapery design), including a color choice, or including an uploaded pattern. This information is organized into an order that can include an identification of the user and the selected drapery design, and the user can then pay online to have drapery made using the selected pattern. Once the transaction is completed, the order is finished and in step 508 the order is provided to a server or similar computing resource for recordation and subsequent completion. In step 510 the order is processed by configuring a printing system (e.g. 114) to print the selected pattern corresponding to the order onto a blank drapery to produce a printed drapery. A printer of the printing system prints the pattern onto a transfer sheet, and in step 512 the transfer sheet is aligned with a blank drapery. In step 514 the blank drapery and aligned transfer sheet are passed through a transfer device (e.g. 206) to infuse or sublimate the ink material from the printed transfer sheet 204 into the fabric of the printing side 124 of the blank drapery to create the printed drapery in step 516. In step 518 the grommets are added in the hole along the top edge or side of the printed drapery, and at the end the grommeted, printed drapery is ready for packaging and shipping to fulfil the order. When the blank drapery is a double sided blank drapery, meaning that both sides of the blank drapery can be printed, steps 504 to 514 can be repeated for the other side of the double sided blank drapery prior to completing step 518.

The inventive disclosure described herein allows a manufacturer to create and sell custom-made drapery without having to buy and inventory various different source materials. Instead, the manufacturer can use assembled blank draperies, which do not require sewing, or otherwise joining of textile layers together by the manufacturer. Rather, the manufacturer simply uses a blank drapery and produces a printed drapery. The only finishing required is to add grommets after the printing process. Accordingly, the inventive process allows a manufacturer to create a near endless variety of drapery while having only to source printing materials, grommets, and blank draperies, and only print the selected pattern onto the blank drapery and then apply the grommets.

What is claimed is:

1. A method for making grommeted draperies, comprising:
receiving, at a server from a client device, a selection of a selected drapery design;
configuring a drapery printer with the selected drapery design by transmitting a digital representation of the selected drapery design to a printer controller of the drapery printer;
printing the selected drapery design onto a blank drapery to produce a printed drapery, wherein the blank drapery is a fully assembled blackout drapery having holes punched therethrough along a top edge, wherein the holes are sized to receive a grommet; and
installing a plurality of grommets into the holes along the top edge of the printed drapery to produce a finished drapery.

2. The method of claim 1, wherein printing the selected drapery design comprises printing the selected drapery design using sublimation printing.

3. The method of claim 2, wherein printing the selected drapery design comprises:
printing the selected drapery design in a mirror image of the selected drapery design onto a transfer sheet using sublimation inks to produce a printed transfer sheet;
aligning the printed transfer sheet onto a printing side of the blank drapery with an ink side of the transfer sheet against the printing side of the blank drapery, wherein the printing side of the blank drapery is made of a polyester material; and
passing the blank drapery with the transfer sheet together through a transfer device that sublimates the sublimation ink into the printing side of the blank drapery to produce the printed drapery.

4. The method of claim 1, wherein printing the selected drapery design onto the blank drapery to produce the printed drapery is performed by printing ink directly onto a printing side of the blank drapery.

5. The method of claim 1, wherein installing the plurality of grommets comprises installing the plurality of grommets by snapping together opposing grommet halves in each one of the holes.

6. The method of claim 1, further comprising, prior to installing the plurality of grommets, printing another design on an opposing side of the blank drapery.

7. The method of claim 1, wherein printing the selected drapery design includes printing a background color.

8. The method of claim 1, wherein receiving the selection of the selected drapery design comprises receiving an uploaded design image from the client device.

9. A grommeted drapery, comprising:
a blackout side;
a printed side coupled to the blackout side, the printed side being printed with a selected drapery design; and
a plurality of grommets along a top edge of the grommeted drapery, each one of the plurality of grommets passing through both the blackout side and the printed side; and
wherein the printed side is printed while attached to the blackout side as a blank drapery, and wherein the blank drapery includes a plurality of grommet holes, and wherein the printed side is printed before the plurality of grommets are installed in the plurality of grommet holes.

10. The grommeted drapery of claim 9, wherein the printed side is printed by:
printing a mirror image of the selected drapery design onto a transfer sheet using sublimation ink;
aligning the transfer sheet onto a printing side of the blank drapery; and
passing the blank drapery and transfer sheet through a transfer device that applies heat and pressure to the transfer sheet and the blank drapery thereby cause the sublimation ink to sublimate into the printing side of the blank drapery to create the printed side.

11. The grommeted drapery of claim 9, wherein the printed side of the printed drapery is printed by printing ink directly onto a printing side of the blank drapery.

12. A method for producing grommeted draperies while minimizing inventorying of materials, comprising:
providing, by a server, a web page including client-side code that allows a user at a client device to browse a plurality of drapery designs and indicate a selection of one of the plurality of drapery designs;
receiving, at the server, an indication of a selection of a drapery design;
creating an order for fulfilment including the indication of the selection of the drapery design as a selected drapery design and an identification of the user;
configuring a drapery printer with the selected drapery design by transmitting a digital representation of the selected drapery design to a printer controller of the drapery printer;
printing the selected drapery design onto a blank drapery to produce a printed drapery, wherein the blank drapery is a fully assembled blackout drapery having holes punched therethrough along a top edge, wherein the holes are sized to receive a grommet; and
after printing the selected drapery design onto the blank drapery to produce the printed drapery, installing a plurality of grommets into the holes along the top edge of the printed drapery to produce a finished drapery.

13. The method of claim 12, wherein printing the selected drapery design comprises printing the selected drapery design using sublimation printing.

14. The method of claim 13, wherein printing the selected drapery design comprises:
printing the selected drapery design in a mirror image of the selected drapery design onto a transfer sheet using sublimation inks to produce a printed transfer sheet;
aligning the printed transfer sheet onto a printing side of the blank drapery with an ink side of the transfer sheet against the printing side of the blank drapery, wherein the printing side of the blank drapery is made of a polyester material; and
passing the blank drapery with the transfer sheet together through a transfer device that sublimates the sublimation ink into the printing side of the blank drapery to produce the printed drapery.

15. The method of claim 12, wherein printing the selected drapery design onto the blank drapery to produce the printed drapery is performed by printing ink directly onto a printing side of the blank drapery.

16. The method of claim 12, wherein installing the plurality of grommets comprises installing the plurality of grommets by, for each hole, snapping together opposing grommet halves.

17. The method of claim 12, further comprising, prior to installing the plurality of grommets, printing another design on an opposing side of the blank drapery.

18. The method of claim 12, wherein printing the selected drapery design includes printing a background color.

19. The method of claim 12, wherein receiving the selection of the selected drapery design comprises receiving an uploaded design image from the client device.
